(19) United States
(12) Patent Application Publication
(10) Pub. No.: US 2010/0146141 A1
(43) Pub. Date: Jun. 10, 2010

(54) TRANSMISSION METHOD, TRANSMISSION APPARATUS, RECEPTION METHOD, RECEPTION APPARATUS OF DIGITAL BROADCASTING SIGNAL

(75) Inventors: Hyoung Soo Lim, Daejeon (KR); Hyun-Chool Shin, Seoul (KR); Jae Hyun Seo, Daejeon (KR); Heung Mook Kim, Daejeon (KR); Yong Tae Lee, Daejeon (KR); Sung Ik Park, Daejeon (KR); Jong Soo Lim, Daejeon (KR); Soo In Lee, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/602,216

(22) PCT Filed: May 30, 2008
(86) PCT No.: PCT/KR08/03073

§ 371 Date: Nov. 30, 2009

(30) Foreign Application Priority Data
May 31, 2007 (KR) 10-2007-0053247
May 29, 2008 (KR) 10-2008-0050258

(51) Int. Cl. G06F 15/16

(52) U.S. Cl. 709/231

(57) ABSTRACT

The present invention relates to a method and apparatus for transmitting digital broadcasting signals and a method and apparatus for receiving digital broadcasting signals that divide a stream into a plurality of layers according to characteristics of the stream, that independently process the layers, and that dynamically allocate frequencies on the basis of the processed signals. A method of transmitting digital broadcasting signals includes dividing a single stream into a plurality of layers according to characteristics of the stream; performing encoding and mapping on each of the layers; and dynamically allocating a frequency to each of the layers on the basis of the number of symbols for each layer.

### TECHNICAL FIELD

The present invention relates to a method and apparatus for transmitting digital broadcasting signals and a method and apparatus for receiving digital broadcasting signals that divide a stream into a plurality of layers according to characteristics of the stream, that independently process the layers, and that dynamically allocate frequencies on the basis of the processed signals.

The present invention was supported by the IT R&D program of MIC/IITA [2006-S-016-02, Development of Terrestrial DTV Repeater Technology].

### BACKGROUND ART

In a general digital terrestrial digital broadcasting system, one base station transmits digital broadcasting signals to all terminals in a service area using the same scheme. That is, the base station collectively transmits, through a single transport layer, a plurality of different service streams that are transmitted through one channel, without considering characteristics of each stream. In this case, it is difficult to maximize service efficiency since the streams are collectively transmitted without considering the performance of the terminals.

Therefore, a technique for reflecting the characteristics of streams in a frequency domain has been developed. The ISDB-T standard of Japan is designed to divide a frequency domain into a predetermined number of subcarrier units and transmit a plurality of streams in parallel. However, in the ISDB-T standard, the subcarrier groups are of the same size. Therefore, the ISDB-T standard of Japan has low flexibility in the use of frequency resources, and there is much room for improvement in frequency efficiency.

Thus, a method that more efficiently uses frequency resources is needed.

The above information disclosed in this Background section is only for enhancement of understanding of the background of the invention and therefore it may contain information that does not form the prior art that is already known in this country to a person of ordinary skill in the art.

### DETAILED DESCRIPTION

### Technical Problem

The present invention has been made in an effort to provide a method and apparatus for transmitting digital broadcasting signals and a method and apparatus for receiving digital broadcasting signals that divide a stream into a plurality of layers according to characteristics of the stream, that independently process the layers, and that dynamically allocate frequencies on the basis of the processed signals.

### Technical Solution

According to an aspect of the present invention, a method of transmitting digital broadcasting signals is provided.

The method of transmitting digital broadcasting signals includes dividing a single stream into a plurality of layers according to characteristics of the stream, performing encoding and mapping on each of the layers, and dynamically allocating a frequency to each of the layers on the basis of a number of symbols for each layer.

The dividing of the single stream may include dividing the single stream into predetermined stream units, determining the importance of the divided stream units, and allocating the divided stream units to each of the plurality of layers on the basis of the determined importance.

The dynamic allocation of the frequency may include determining bandwidth of each of the layers on the basis of the number of symbols for each layer, and allocating each layer to a frequency domain with the determined bandwidth. The bandwidth may be determined in proportion to the number of symbols for each layer.

When channel information is known, in the allocation of the frequency domain, a layer having high importance may be allocated to a band in which a channel is stabilized. When no channel information is known, in the allocation of the frequency domain, frequency hopping may be used to repeatedly select frequency domain candidates at predetermined time intervals.

The performing of encoding and mapping on each layer may include performing channel encoding on each layer in order to correct a random error, and performing mapping on each layer according to a predetermined scheme.

The dividing of the single stream may further include receiving a plurality of streams, multiplexing the plurality of streams into a single stream, and performing outer encoding on the multiplexed stream for error correction.

The method of transmitting digital broadcasting signals may further include performing frequency interleaving on each of the layers, completing the format of the entire transmission data including additional control signals, and performing inverse fast Fourier transform on the completed transmission data.

According to another aspect of the present invention, an apparatus for transmitting digital broadcasting signals is provided.

The apparatus for transmitting digital broadcasting signals includes: a service divider that divides a single stream into a plurality of layers according to characteristics of the stream; a channel encoder that performs channel encoding on each of the layers in order to correct a random error; a mapper that performs mapping on each of the layers according to a predetermined scheme; and a dynamic band allocating unit that dynamically allocates a frequency to each of the layers on the basis of the number of symbols for each layer.

The apparatus for transmitting digital broadcasting signals may further include a stream multiplexer that receives a plurality of streams and multiplexes the plurality of streams into a single stream, and an outer encoder that performs outer encoding on the multiplexed stream for error correction. The apparatus for transmitting digital broadcasting signals may further include a frequency interleaver that performs frequency interleaving on each of the layers, a framing unit that completes formatting of the entire transmission data including additional control signals, and an inverse fast Fourier transformer that performs inverse fast Fourier transform on the completed transmission data.

According to still another aspect of the present invention, a method of receiving digital broadcasting signals is provided.

The method of receiving digital broadcasting signals includes selecting a sub-stream to be received from input information, performing demapping on each layer according to a predetermined scheme, performing channel decoding, and merging services for the layers.

The method of receiving digital broadcasting signals may further include performing fast Fourier transform on a received signal, and performing inverse frequency interleaving on the transformed stream.

The method of receiving digital broadcasting signals may further include performing outer decoding in order to correct an error of the service-merged stream, and demultiplexing the outer-decoded stream into a plurality of service streams.

According to yet another aspect of the present invention, an apparatus for receiving digital broadcasting signals is provided.

The apparatus for receiving digital broadcasting signals includes a band selection dynamic band selecting unit that selects each layer to be received from information on a plurality of layers, a de-mapper that performs demapping on the selected layers according to a predetermined scheme, a channel decoder that performs channel decoding on the demapped stream, and a service merger that merges services of the selected layers.

The apparatus for receiving digital broadcasting signals may further include a fast Fourier transformer that performs fast Fourier transform on a received signal, and an inverse frequency interleaver that performs inverse frequency interleaving on the transformed stream.

The apparatus for receiving digital broadcasting signals may further include an outer decoder that performs outer decoding in order to correct an error of the service-merged stream, and a demultiplexer that demultiplexes the outer-decoded stream into a plurality of service streams.

### Advantageous Effects

According to the present invention, it is possible to provide a method and apparatus for transmitting digital broadcasting signal streams and a method and apparatus for receiving digital broadcasting signal streams that divide a stream into a plurality of layers according to characteristics of the stream, that independently process the layers, and that dynamically allocate frequencies on the basis of the processed signals.

### BRIEF DESCRIPTION OF THE DRAWINGS

FIG. 1 is a diagram illustrating the structure of an apparatus for transmitting digital broadcasting signals according to an exemplary embodiment of the present invention.

FIG. 2 is a conceptual diagram illustrating the operation of a stream multiplexer 110.

FIGS. 3 and 4 are conceptual diagrams illustrating the operation of a service divider 130.

FIG. 5 is a diagram illustrating examples of a channel encoder 140 and a mapper 150.

FIG. 6 is a diagram illustrating the number of symbols generated depending on the coding rate of the channel encoder 140 and the mapping scheme of the mapper 150.

FIG. 7 is a flowchart illustrating the operation of a dynamic band allocating unit (DBA) 160 that determines a bandwidth.

FIG. 8 is a diagram illustrating various examples of allocating a frequency domain to each layer according to the exemplary embodiment of the present invention.

FIG. 9 is a flowchart illustrating a method of transmitting digital broadcasting signals according to an exemplary embodiment of the present invention.

FIG. 10 is a block diagram illustrating an apparatus for receiving digital broadcasting signals according to an exemplary embodiment of the present invention.

FIG. 11 is a flowchart illustrating a method of receiving digital broadcasting signals according to an exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

A method and apparatus for transmitting digital broadcasting signals and a method and apparatus for receiving digital broadcasting signals according to exemplary embodiments of the present invention divide a service stream into a plurality of layers according to characteristics of the stream, independently process the layers, and transmit the stream through sub-bands having bandwidths that are dynamically allocated.

Hereinafter, a method and apparatus for transmitting digital broadcasting signals and a method and apparatus for receiving digital broadcasting signals according to exemplary embodiments of the present invention will be described with reference to the accompanying drawings.

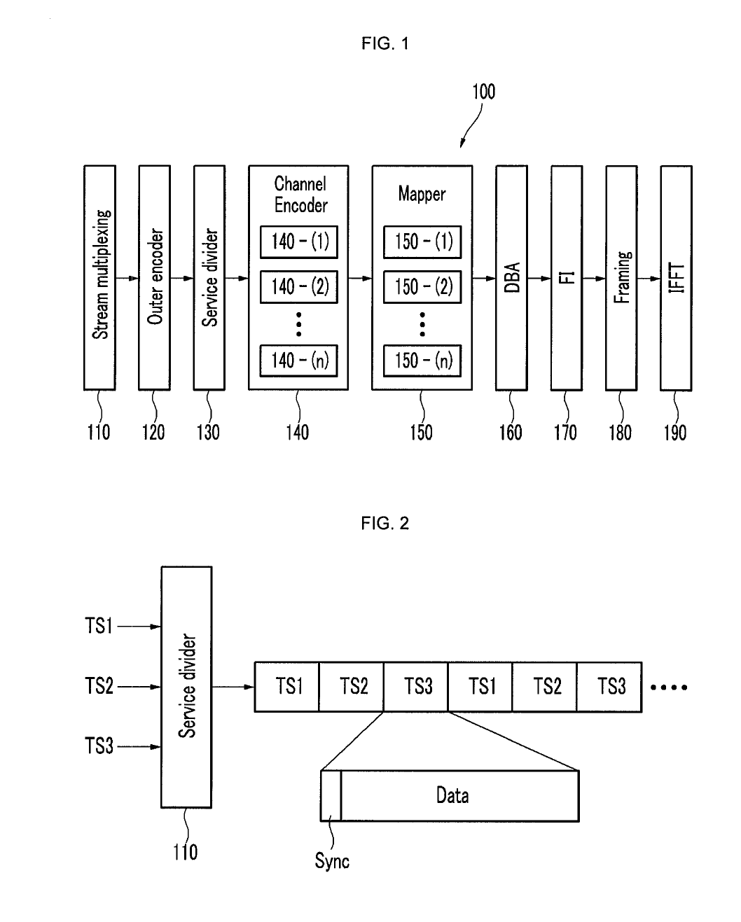

FIG. 1 is a diagram illustrating the structure of a digital broadcasting signal transmitting apparatus according to an exemplary embodiment of the present invention.

Referring to FIG. 1, a digital broadcasting signal transmitting apparatus 100 according to the exemplary embodiment of the present invention includes a stream multiplexer 110, an outer encoder 120, a service divider 130, a channel encoder 140, a mapper 150, a dynamic band allocating (DBA) unit 160, a frequency interleaver (FI) 170, a framing unit 180, and an inverse fast Fourier transformer (IFFT) 190. The structure of each of the components shown in FIG. 1 will be described in detail below.

The stream multiplexer 110 receives a plurality of transport streams (TS), and multiplexes the streams into a single stream.

FIG. 2 is a conceptual diagram illustrating the operation of the stream multiplexer 110.

FIG. 2 shows an example in which three transport streams TS1, TS2, and TS3 are input to the stream multiplexer 110. The stream multiplexer 110 divides the input three transport streams TS1, TS2, and TS3 into a predetermined stream unit, and rearranges the divided stream unit to generate a single stream in which the transport streams TS1, TS2, and TS3 are sequentially repeated. The divided stream unit may include synchronization information and data information.

Referring to FIG. 1 again, the outer encoder 120 performs outer encoding for error correction on the multiplexed stream received from the stream multiplexer 110.

The service divider 130 divides the stream signal outer-encoded by the outer encoder 120 into a plurality of layers according to the characteristics of the stream. Specifically, the service divider 130 allocates the received single stream to a plurality of layers according to its importance and function.

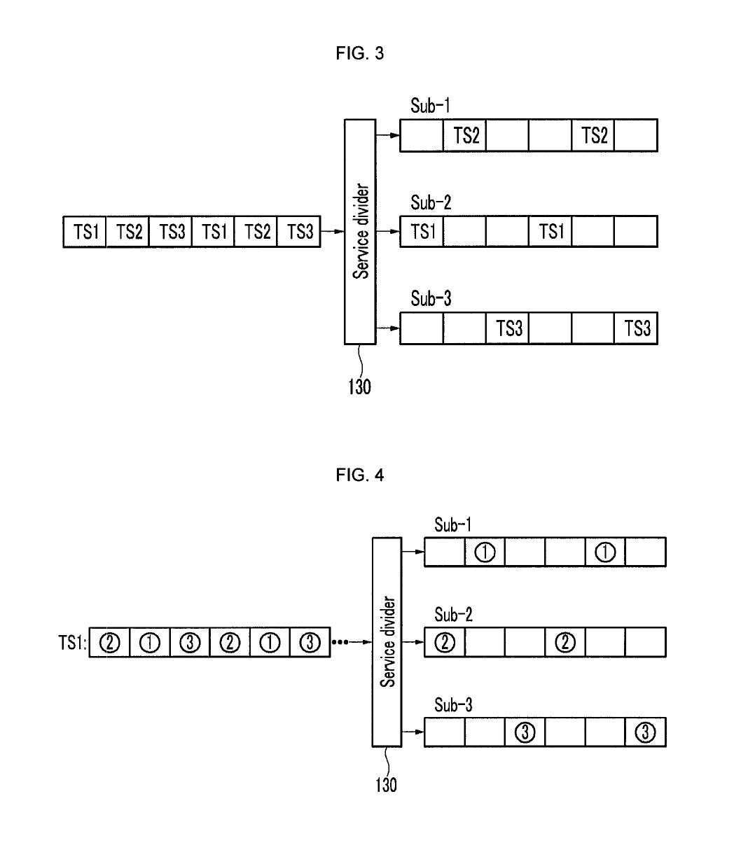

FIGS. 3 and 4 are conceptual diagrams illustrating the operation of the service divider 130.

FIG. 3 is a conceptual diagram illustrating the operation of the service divider 130 when the service divider 130 receives a single stream including the three streams TS1, TS2, and TS3.

Referring to FIG. 3, when the relative importance of three input streams TS1, TS2, and TS3 are set so as to satisfy TS2>TS1>TS3, the service divider 130 divides a single stream into a plurality of layers sub-1, sub-2, and sub-3 on the basis of the relative importance of each stream.

FIG. 4 is a conceptual diagram illustrating the operation of the service divider 130 when the service divider 130 receives a single stream including one input stream TS1.

Assuming that the importance of the stream is determined in a predetermined byte unit, the service divider 130 checks the importance of predetermined byte streams, and allocates the predetermined byte streams to a plurality of layers sub-1, sub-2, and sub-3 on the basis of the checked importance.

When the importances of the predetermined byte streams are determined as \textcircled{1}, \textcircled{2}, and \textcircled{3} and the relative importance thereof satisfies \textcircled{1}>\textcircled{2}>\textcircled{3}, the service divider 130 divides a single stream into a plurality of layers sub-1, sub-2, and sub-3 in a predetermined byte unit.

FIGS. 3 and 4 show examples of a method of allocating a single stream to a plurality of layers in the service divider 130, and various methods may be used to allocate a single stream to a plurality of layers.

In the digital broadcasting signal transmitting apparatus according to the exemplary embodiment of the present invention, the service divider 130 is provided in an early stage of the transmitting apparatus to divide a service stream into a plurality of layers in consideration of, for example, the importance, kind, and characteristics of the service stream.

Referring to FIG. 1 again, the channel encoder 140 includes channel encoders 140-1, 140-2, . . . , 140-(n) for a plurality of layers, and performs channel encoding on signals of the plurality of layers in order to correct random channel errors.

The mapper 150 includes mappers 150-1, 150-2, . . . , 150-(n) for the plurality of layers, and maps the signals of the plurality of layers to the layers according to predetermined mapping schemes.

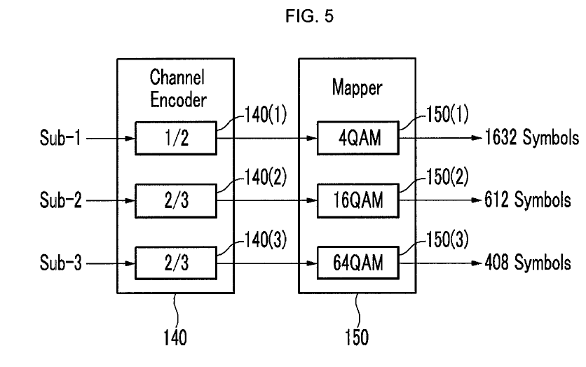

FIG. 5 is a diagram illustrating examples of the channel encoder 140 and the mapper 150. FIG. 5 shows an example in which a single stream is divided into three layers sub-1, sub-2, and sub-3, and channel encoding schemes and mapping schemes for the three layers sub-1, sub-2, and sub-3 are shown in Table 1.

TABLE 1

| | Channel coding rate | Mapping scheme |
|---|---|---|
| Sub-1 | 1/2 | 4 QAM |
| Sub-2 | 2/3 | 16 QAM |
| Sub-3 | 2/3 | 64 QAM |

Referring to FIG. 5, when a 204-byte signal is input to the channel encoder 140, 1632 symbols are output to the first layer sub-1, 612 symbols are output to the second layer sub-2, and 408 symbols are output to the third layer sub-3 by the channel encoder 140 and the mapper 150.

That is, the number of symbols output to each layer depends on the coding rate of the channel encoder 140 and the mapping scheme of the mapper 150. Therefore, the importance of each of the plurality of layers is represented by the number of symbols for each layer, which is the transmission width of each layer in the overall transmission bandwidth. That is, a large number of symbols are generated from the stream that is determined to have high importance in FIGS. 3 and 4, and the stream accounts for a large portion in the overall available bandwidth.

Specifically, since 1632, 612, and 408 symbols are respectively output to the three layers sub-1, sub-2, and sub-3 shown in FIG. 5, the relative importances thereof are 1632:612:408, that is, 1:0.375:0.25.

FIG. 5 shows examples of the channel encoder 140 and the mapper 150, and various combinations of the channel encoder 140 and the mapper 150 can be made according to the importance of the stream.

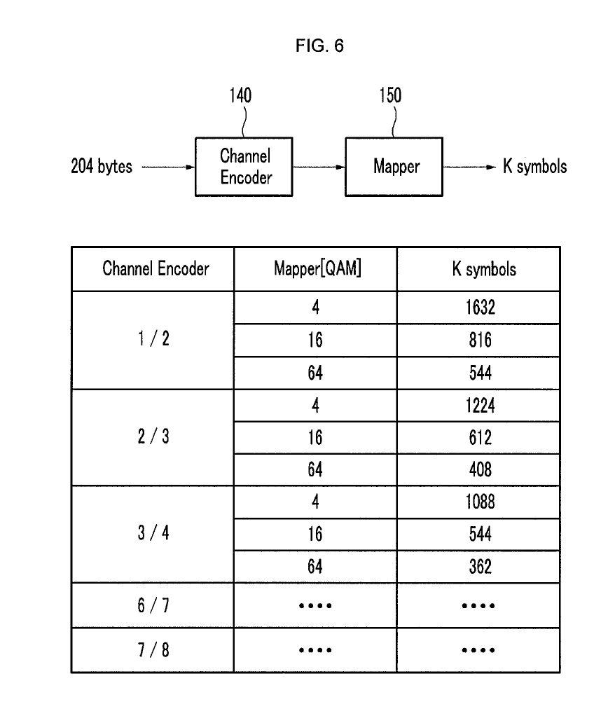

FIG. 6 is a diagram illustrating the number of symbols generated depending on the coding rate of the channel encoder 140 and the mapping scheme of the mapper 150.

Referring to FIG. 6, when the coding rate of the channel encoder 140 for all of the plurality of layers is set to ½ and the mapping schemes of the mapper 150 for the three layers sub-1, sub-2, and sub-3 are respectively set as 4 QAM, 16 QAM, and 64 QAM, 1632, 816, and 544 symbols are generated for the layers. In this case, the relative importances of the layers are 1632:816:544, that is, 1:0.5:0.33. As such, it is possible to reflect various importances according to a combination of the channel encoder 140 and the mapper 150.

Referring to FIG. 1 again, the dynamic band allocating unit (DBA) 160 determines the bandwidth of each layer on the basis of the number of symbols of the layer, and allocates each layer to an appropriate frequency band.

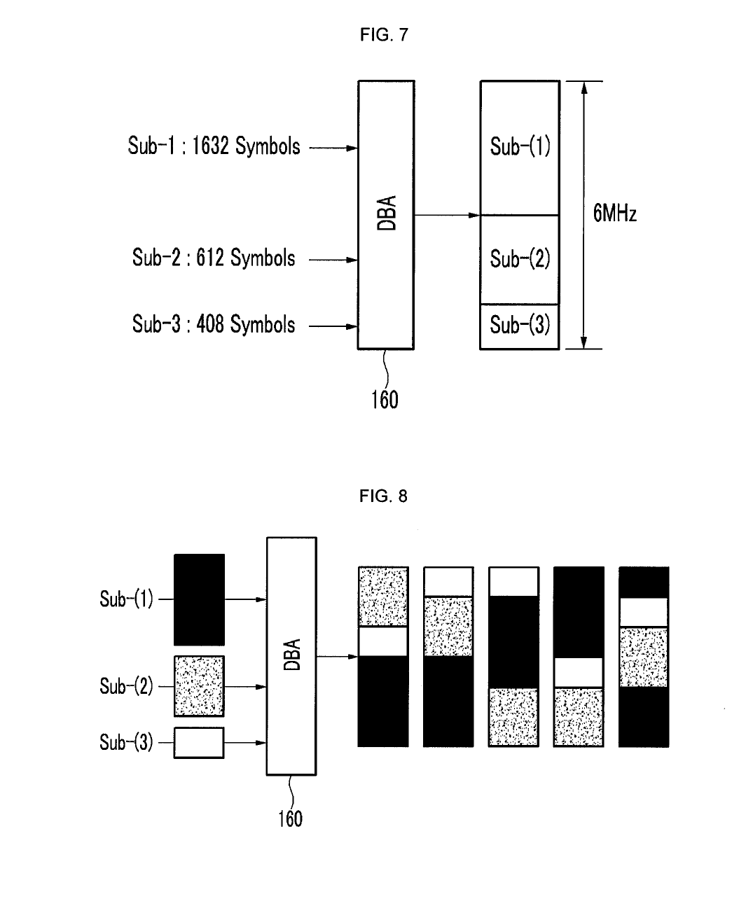

FIG. 7 is a diagram illustrating the operation of the dynamic band allocating unit (DBA) 160 determining the bandwidth. In this case, it is assumed that 1632, 816, and 544 symbols are generated for three layers sub-1, sub-2, and sub-3, respectively, and the relative importances thereof are 1:0.375:0.25.

When the overall transmission bandwidth is 6 MHz, the first layer sub-1 is allocated with ( 1/1.625)*6 MHz=3.692 MHz, the second layer sub-2 is allocated with ( 0.375/1.625)*6 MHz=1.385 MHz, and the third layer sub-3 is allocated with ( 0.25/1.625)*6 MHz=0.923 MHz.

Next, a method of allocating the bandwidth of each layer in the overall bandwidth will be described. In the specification, two methods of allocating the bandwidth of each layer in the overall bandwidth are considered.

A first method is applied when channel information is known, and the second method is applied when no channel information is known.

When channel information is known, for example, a high-importance layer is allocated to a band in which a channel is stabilized, and a layer having a high channel coding rate is allocated to a band in which channel distortion is large. In this way, it is possible to optimize receiving performance.

When no channel information is known, which corresponds to the current terrestrial broadcasting system, it is difficult to determine a standard for frequency domain allocation. Therefore, for example, frequency hopping may be used to repeatedly select various frequency domain candidates at predetermined time intervals. In this case, it is possible to prevent a specific layer from being allocated to a specific domain, and to uniformly distribute channel distortion to all the layers.

FIG. 8 is a diagram illustrating various examples of allocating a frequency domain to each layer according to the exemplary embodiment of the present invention.

Referring to FIG. 1, the frequency interleaver (FI) 170 performs frequency interleaving on each layer.

The framing unit 180 completes the format of the entire transmission data including additional control signals. That is, the framing unit transmits resource allocation information through a control channel for each frame or at predetermined frame intervals.

The inverse fast Fourier transformer (FFT) 190 performs inverse fast Fourier transform on the received signal.

Next, a method of transmitting digital broadcasting signals according to an exemplary embodiment of the present invention will be described with reference to the drawings.

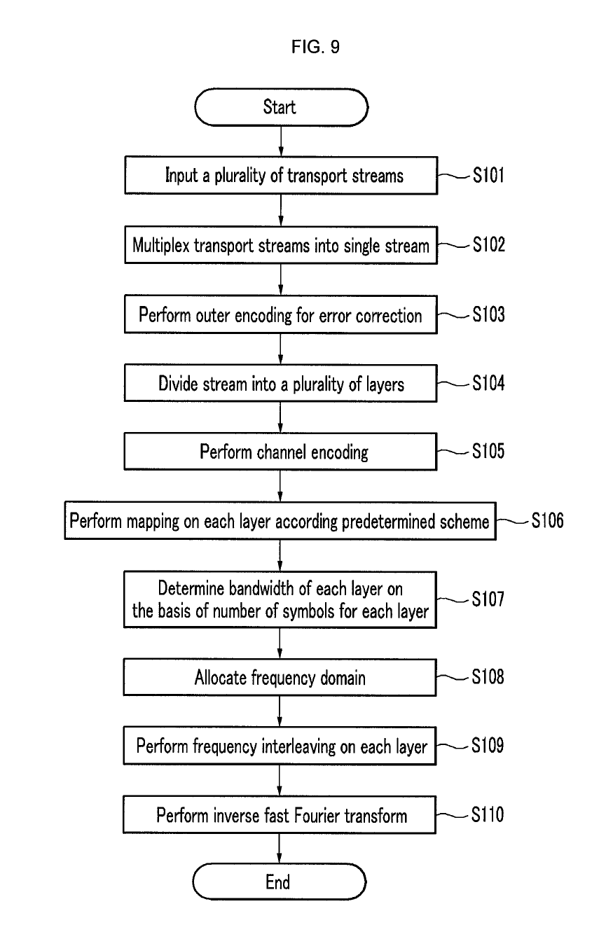

FIG. 9 is a flowchart illustrating the method of transmitting digital broadcasting signals according to the exemplary embodiment of the present invention. Referring to FIG. 9, the digital broadcasting signal transmitting apparatus 100 according to the exemplary embodiment of the present invention receives a plurality of transport streams (S101), multiplexes the streams into a single stream (S102), and performs outer encoding for error correction (S103).

Then, the digital broadcasting signal transmitting apparatus 100 divides the outer-encoded stream signal into a plurality of layers according to application service characteristics (S104). That is, the digital broadcasting signal transmitting apparatus allocates the received single stream to a plurality of layers according to the importance and function of each frame.

Subsequently, the digital broadcasting signal transmitting apparatus 100 performs channel encoding on the signals of the plurality of layers in order to correct random channel errors (S105), and maps the signals to the layers according to predetermined mapping schemes (S106).

Then, the digital broadcasting signal transmitting apparatus 100 determines the bandwidth of each layer on the basis of the number of symbols of the layer (S107), and allocates each layer to an appropriate frequency domain (S108).

Then, the digital broadcasting signal transmitting apparatus 100 performs frequency interleaving on each layer (S109), completes the format of the entire transmission data including additional control signals, and performs inverse fast Fourier transform (S110).

Next, a method and apparatus for receiving digital broadcasting signals according to an exemplary embodiment of the present invention will be described in detail with reference to the drawings.

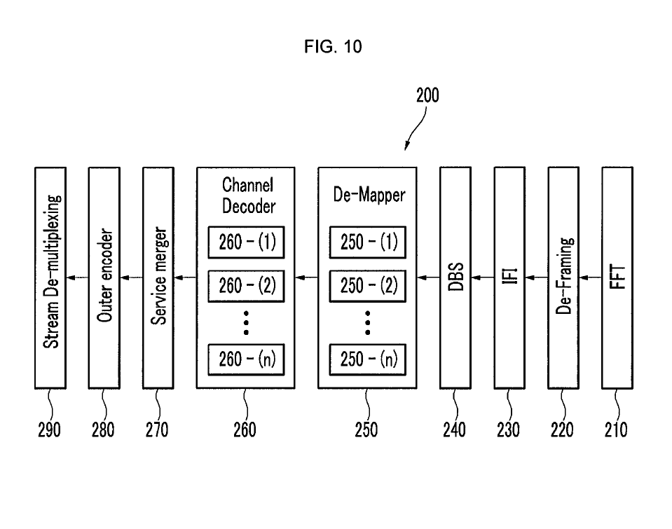

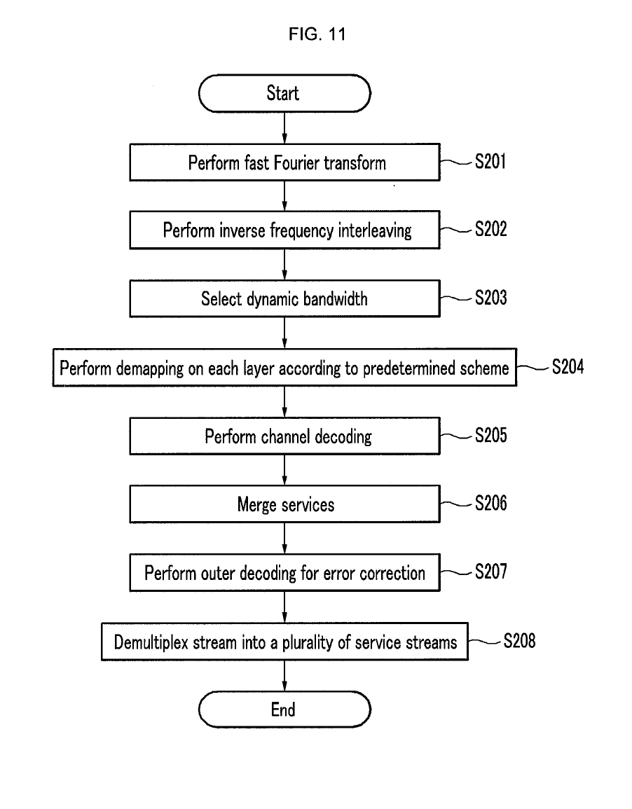

FIG. 10 is a block diagram illustrating a digital broadcasting signal receiving apparatus 200 according to an exemplary embodiment of the present invention. Referring to FIG. 10, the digital broadcasting signal receiving apparatus 200 according to the exemplary embodiment of the present invention includes a fast Fourier transformer (FFT) 210, a de-framing unit 220, an inverse frequency interleaver (IFI) 230, a dynamic band selecting unit (DBS) 240, a de-mapper 250, a channel decoder 260, a service merger 270, an outer decoder 280, and a stream demultiplexer 290. The components shown in FIG. 10 perform the inverse functions of the components shown in FIG. 1. The structure of each of the components shown in FIG. 10 will be described in detail below.

The fast Fourier transformer (FFT) 210 performs fast Fourier transform on a received signal, and the de-framing unit 220 separates a control signal from the received signal.

The inverse frequency interleaver (IFI) 230 performs inverse frequency interleaving.

The dynamic band selecting unit (DBS) 240 dynamically selects the band of the received signal. That is, the dynamic band selecting unit selectively receives sub-streams suitable for the purpose and performance of the digital broadcasting signal receiving apparatus 200 from information transmitted from the digital broadcasting signal transmitting apparatus 200.

The de-mapper 250 includes first to N-th de-mapper units 250_(1), 250_(2) . . . , and 250_(N). The de-mapper 250 performs demapping on each layer according to a predetermined demapping scheme,

The channel decoder 260 includes first to N-th channel decoder units 260_(1), 260_(2) . . . , and 260_(N). The channel decoder 260 performs channel decoding on each layer.

The service merger 270 merges services for the layers, and restores service data having a level that the digital broadcasting signal receiving apparatus 200 wants to restore.

The outer decoder 280 performs outer decoding for error correction. The stream demultiplexer 290 performs demultiplexing in the form of a single stream.

Next, a method of receiving digital broadcasting signals according to an exemplary embodiment of the present invention will be described in detail with reference to the drawings.

FIG. 11 is a flowchart illustrating the method of receiving digital broadcasting signals according to the exemplary embodiment of the present invention. Referring to FIG. 11, the digital broadcasting signal receiving apparatus 200 performs fast Fourier transform (S201), and then performs inverse frequency interleaving (S202). Then, the digital broadcasting signal receiving apparatus 200 dynamically selects a band (S203), performs demapping on each layer according to a predetermined demapping scheme (S204), and performs channel decoding (S205).

The digital broadcasting signal receiving apparatus 200 then merges services for the layers (S206), performs outer decoding for error correction (S207), and demultiplexes the outer-decoded stream into a plurality of service streams (S208).

According to this exemplary embodiment of the present invention, it is possible to support various qualities of services for various future services by effectively and adaptively using frequency resources according to the characteristics of service streams. In addition, it is possible to improve the receiving performance of a receiving apparatus by improving frequency efficiency.

That is, according to the exemplary embodiment of the present invention, it is possible to increase flexibility in the use of frequency resources and improve frequency efficiency by dynamically allocating frequency resources to a plurality of streams in the digital broadcasting system, if necessary.

The method of transmitting digital broadcasting signals according to the exemplary embodiment of the present invention has high flexibility in the use of frequency resources. Therefore, the method can support various qualities of services. As an example of the usage of the method, operative association with scalable video coding (SVC) may be considered.

The scalable video coding (SVC) is a compression technique that constructs one bit stream (i.e., which provides spatial, image quality, and temporal scalability) that allows one image content to have various spatial resolutions, various image qualities, and various frame rates, and enables various terminals to receive bit streams according to their performances and restore the bit streams.

When the SVC is used, a plurality of sub-streams, which are SVC output, that is, a plurality of sub-streams allocated to multiple layers may be directly input to the channel encoder 140 without passing through the service divider 130 of the digital broadcasting signal transmitting apparatus 100 according to the exemplary embodiment of the present invention, and the sub-streams may be independently processed up to the dynamic band allocating unit (DBA) 160.

The above-described exemplary embodiment of the present invention can be applied to programs that allow computers to execute functions corresponding to the configurations of the exemplary embodiments of the invention or recording media including the programs as well as the method and apparatus. Those skilled in the art can easily implement the applications from the above-described exemplary embodiments of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the present invention, it is possible to provide a method and apparatus for transmitting digital broadcasting signal streams and a method and apparatus for receiving digital broadcasting signal streams that divide a stream into a plurality of layers according to characteristics of the stream, independently process the layers, and dynamically allocate frequencies on the basis of the processed signals.

1-18. (canceled)

19. A method of transmitting a digital broadcasting signal, the method comprising:
arranging data stream layers;
performing encoding and mapping on each of the data stream layers; and
allocating resources to each data stream layer on the basis of the number of symbols for each data stream layer.

20. The method of claim 19, wherein the resources are frequency resources.

21. The method of claim 19, wherein the allocation of the resources comprises:
determining bandwidth of each data stream layer on the basis of the number of symbols for each data stream layer; and
allocating each data stream layer to a frequency domain with the corresponding bandwidth.

22. The method of claim 21, wherein the bandwidth is determined in proportion to the number of symbols for each data stream layer.

23. The method of claim 21, wherein the allocation of each data stream layer comprises allocating a data stream layer having relatively high importance to a band in which a channel is stabilized when channel information is known.

24. The method of claim 21, wherein allocation of each data stream layer comprises repeatedly selecting frequency domain candidates at a predetermined time interval by frequency hopping when no channel information is known.

25. The method of claim 19, wherein the performing of encoding and mapping on each layer comprises:
performing channel encoding on each data stream layer to correct a random error; and
performing mapping on each data stream layer according to a predetermined scheme.

26. The method of claim 19, further comprising:
performing frequency interleaving on the data stream layers to which the resources are allocated;
adding a control signal to the data stream layers in which the frequency interleaving is performed to generate transmission data; and
performing inverse fast Fourier transform on the transmission data.

27. An apparatus for transmitting a digital broadcasting signal, the apparatus comprising:
means for arranging data stream layers;
means for performing encoding and mapping on each of the data stream layers; and
means for allocating resources to each data stream layer on the basis of the number of symbols for each data stream layer.
